(19) United States
(12) Patent Application Publication
(10) Pub. No.: US 2002/0073394 A1
(43) Pub. Date: Jun. 13, 2002

(54) Methodology for increasing yield, manufacturability, and performance of integrated circuits through correction of photolithographic masks

(76) Inventors: Linda Susan Milor, Berkeley, CA (US); Michael Eugene Orshansky, Oakland, CA (US)

Correspondence Address: Linda Milor, 1730 Highland Place #1, Berkeley, CA, 94709, US

(21) Appl. No.: 09/733,412

(22) Filed: Dec. 11, 2000

Related U.S. Application Data
(60) Provisional application No. 60/169,493, filed on Dec. 7, 1999.

(51) Int. Cl. G06F 17/50

(52) U.S. Cl. 716/19; 716/8; 716/11; 716/10; 716/9

(57) ABSTRACT

The present invention is a method to increase yield and performance (speed and power dissipation) of ICs. It involves identifying gates in a layout by location and classification (orientation and neighboring features), and applying mask correction to the gates based on these features, together with the location of the chip in the optical field. Mask correction is applied to each chip having a unique position within the optical field separately. Mask correction involves increasing or decreasing the line widths in the layout of the gate layer of those lines corresponding to transistor gates, depending on a spatial and category-based correction scheme. The present invention further includes a set of methods to determine the mask correction amounts, given limits in mask correction resolution, based on the spatial CD maps for each of the gate categories. Finally, the invention describes a set of methods for predicting and evaluating the effectiveness of a mask correction scheme, the impact of limiting the number of gate categories and the impact of reduced spatial sampling of the CD.

### CROSS-REFERENCE TO RELATED APPLICATIONS

A provisional patent application was filed on Dec. 7, 1999 for this patent, with the application No. 60/169,493. Non-provisional application 60/169,492 is related.

### BACKGROUND OF THE INVENTION

A. Technical Field

The present invention pertains to manufacturing of silicon integrated circuits. The invention is to be applied as a way to increase yield, manufacturability, and performance (speed and power consumption) of CMOS integrated circuits (ICs). The gate critical dimension (CD) of MOS transistors, which influences the yield and performance of ICs, is subject to variability during the semiconductor manufacturing process. The present invention allows utilization of the underlying deterministic structure of gate CD variability for the purpose of circuit performance and yield enhancement. Accurate topological information about CD variation within the optical field is used to modify a photolithography mask, compensating for the observed global and local variation patterns. As a result of correction, greater uniformity of printed gate CDs on wafers is achieved, allowing for higher yield and performance. The present invention describes all the steps required to perform the optimal correction.

B. Background

Achieving the highest possible yield and performance for any given integrated circuit design allows for cost-effective production of the said semiconductor product. For CMOS ICs, yield, speed, and power consumption of ICs are strongly dependent on the amount of current (current drive) supplied by the MOS transistors. Current drive of a MOS transistor is to a large extent determined by the length of the transistor gate. Although an IC is composed of transistors, which are designed to have transistor gates of different lengths, for most ICs, most of the transistors have gates where the length is the minimum manufacturable gate length so that the IC has maximum speed. This minimum manufacturable gate length is called the critical dimension (CD). Because most transistors in an IC are designed to have a minimum gate length, defined as the gate CD, control of the gate CD strongly influences the performance of the IC. For a set of transistors, designed to have the same CD, the smaller CDs give higher current drive, resulting in faster transistors and faster ICs. At the same time, the smaller CDs lead to yield loss due to a variety of mechanisms.

Circuits (ICs) are designed and manufactured in such a way that they operate properly (have high yield) at a certain minimum CD value. This critical dimension of MOS transistors, however, is subject to variability during the semiconductor manufacturing process, and the actual CD of some transistors within the circuit may be smaller than the minimum designed-for CD value, leading to functional failure. For this reason, tight control of the CD is an absolute necessity for achieving high performance and yield of ICs.

The gate CD varies between lots, wafers, across a wafer, and within the optical field (the area of the wafer that is printed with a single exposure of light). Referring to FIG. 1, a wafer 101 containing multiple optical fields is illustrated. An optical field contains one of more ICs. The present invention is concerned with reducing CD variation within the optical field. Since each optical field contains one or more ICs, reducing CD variation within the optical field also reduces CD variation within the ICs.

Variation of the gate CD within the optical field is largely deterministic (non-random). The fact that intra-field variability is largely deterministic means that at different locations within the optical field the CD value is different; thus, spatially separated transistors have distinct current drives, and other important characteristics. The present invention employs statistical decomposition techniques to discover the underlying deterministic structure of the intra-field gate CD variability, for a specific manufacturing process utilizing a specific set of equipment, and utilizes it to achieve greater performance (speed and power dissipation) and yield. This is achieved by increasing the uniformity of printed gate CDs on wafers through photolithographic mask correction.

ICs are fabricated by sequentially manufacturing the “layers” of a design. The gate layer is the one that defines the CDs of the transistors. Manufacturing a layer involves printing, developing, and etching the layer on the silicon wafer surface. The printing step includes exposing the wafer through a photolithographic mask in order to create the desired geometries on the wafer. Consequently, the CDs of the transistors are determined, in part, by the widths of the corresponding lines on the photolithographic mask for the gate layer. Clearly, the CDs of specific transistors can be made to be larger or smaller by increasing or decreasing the widths of the corresponding lines on the photolithographic mask. The present invention involves increasing or decreasing the widths of lines on photolithographic masks for the gate layer to compensate for known patterns of variation of the gate CD the wafers.

The present invention differs from traditional optical proximity correction by incorporating corrections of the gate CD, including both spatial correction, to compensate for lens aberration effects, and correction based on the neighborhood of a gate. In particular, the spatial correction profiles are dependent on the local layout patterns. Thus, the resulting reduction of CD variation is superior to any currently used correction scheme, in which the correction amounts have no spatial dependence.

### BRIEF SUMMARY OF THE INVENTION

It has been known for a long time that the gate CD is subject to variability resulting from the manufacturing process of semiconductors. This invention builds on several important ideas that have been overlooked.

First, lens aberrations and, to a lesser extent, mask errors, contribute significantly to systematic (non-random) gate CD variability within the optical field. The result of the systematic variation is a distinct topological (spatial) map of gate CD over the area of the optical field. In other words, the value of the gate CD depends on the location of the gate within the optical field.

Second, a significant interaction between the global variation due to lens aberrations and local, pattern-dependent variation has not been known or utilized. Accounting for this effect is necessary for achieving the maximal variability reduction after mask correction.

Third, given data for a specific equipment set on gate CD variation as a function of position within the optical field and the neighboring geometries, the present invention involves steps that lead to designing a photolithographic mask for the gate layer compensating for said variation so as to increase the uniformity of gate CDs printed on wafers.

Fourth, the presence of random, stochastic noise influences the choice of correction resolution. Greater correction resolution leads to better uniformity, but increases the cost of correction. The present invention utilizes statistical models in order to provide guidance in selecting the optimal spatial correction resolution.

Fifth, the optimal choice of correction resolution is influenced by the completeness of the spatial measurement (sampling) plan and the completeness of the description of the neighborhoods. A more detailed spatial measurement plan and a more detailed description of the neighboring features of a gate lead to better uniformity, but increase the cost of measurement and monitoring. The present invention utilizes statistical models to provide guidance in selecting the spatial measurement plan and the level of detail needed to describe the neighborhood of a gate.

### BRIEF DESCRIPTION OF THE SEVERAL VIEWS OF THE DRAWING

FIG. 1 shows a top view of a wafer, containing several optical fields;

FIG. 2 displays an example description of the topological (spatial) map of critical dimension (CD) variation across the optical field for a gate with a specific set of neighboring features;

FIG. 3 shows the top view of transistors with vertical and horizontal orientations, with respect to the flat of the wafer;

FIG. 4 shows the top view of six transistors, three with vertical and three with horizontal orientations, with different neighborhoods, so as to illustrate one embodiment of labeling gates according to their orientation and neighborhood;

FIG. 5 shows the top view of a transistor, formed by the intersection of the active and gate layers, where the gate layer is corrected by reducing its width in areas corresponding to the transistor gate;

FIG. 6 shows an example one-dimensional mask correction profile which is discretized to determine the correction amounts for each point in the optical field; and

FIG. 7 shows CD variation reduction as a function of mask resolution, and demonstrates that an empirical model fits the data well.

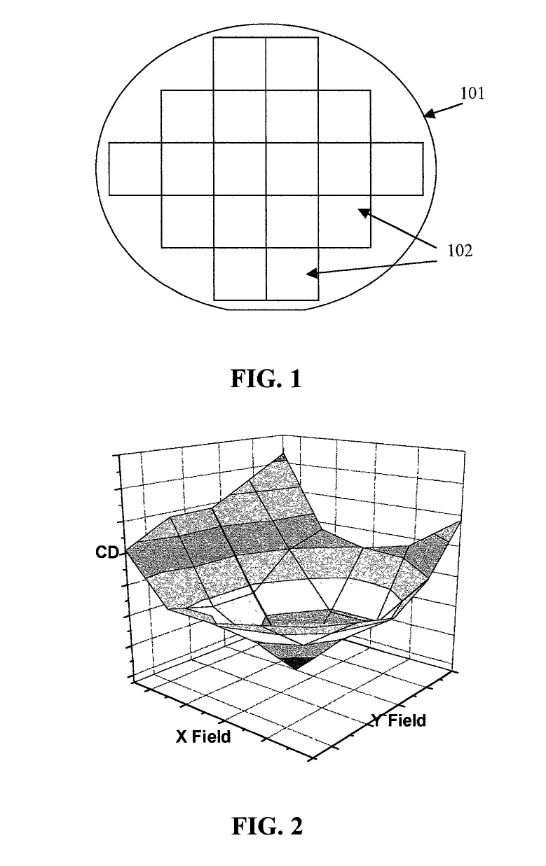

The figures referred to herein are drawn for clarity of illustration and are not necessarily drawn to scale. Moreover, although the figures contain some structures, other structures may be present in each embodiment; these structures have been omitted to enhance clarity of the illustrations. Elements having the same reference number refer to elements having a similar structure and function.

### DETAILED DESCRIPTION OF THE INVENTION

The present invention provides for a multi-step methodology to achieve greater uniformity of printed geometries (transistor gates) leading to superior yield and performance of integrated circuits. The present invention involves designing and analyzing a mask correction algorithm that exploits the fundamentally deterministic nature of variability of the gate critical dimension (CD).

A. Maps of CD Variation

The present invention requires an accurate representation of systematic gate CD variation. Variation in the gate CD comes from global lens aberrations in the lithography system that is used to print the transistor gates (usually composed of polysilicon) on wafers. Variation in the gate CD is also caused by neighboring patterns, for example, the presence or absence of nearby gates, printed on the wafer at the same time. Moreover, the global lens aberrations interact with the local patterns in the neighborhood to produce spatial systematic CD variation that depends on the neighborhood of each gate (other nearby gates and features printed at the same time as the gates). The impact of global lens aberrations on gate CD may be represented as spatial CD maps (a topological surface, describing the variation of the gate CD over the optical field) that depend on the local layout patterns of the particular gate configuration. FIG. 2 shows the spatial CD map for a gate with a specific set of neighboring features.

A gate is most strongly influenced by features that are nearby. Hence the classification of gates according to their neighborhood must be based on the nearby features. Given a physical limitation of what is called the neighborhood of a gate, the number of possible gate configurations is finite, and thus, it is possible to classify each gate in a layout as belonging to one such category.

One possible embodiment of the classification of gates involves labeling gates depending on their orientation in the layout (vertical, horizontal, 45 degrees, 135 degrees, etc.), spacing to the neighboring gates (nearest and possibly more distant neighbors), and the relative position of the surrounding gates (the neighbors to the west vs. east). Other categories may be added if justified by the complexity of the manufacturing process.

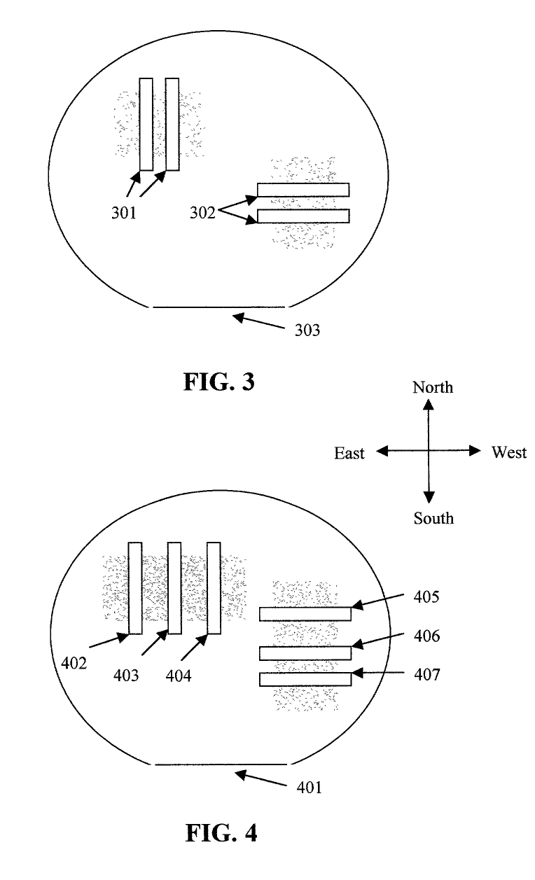

The orientation, vertical 301 vs. horizontal 302, is determined with respect to the flat of the wafer 303, as illustrated in FIG. 3. Other orientations could be involved, as would be apparent to one of ordinary skill in the art.

Referring to FIG. 4, one embodiment of the classification of gates includes attaching a label representing the orientation and a description of the neighborhood. This embodiment of the labeling method of the neighborhood involves specifying the distance to the closest neighbor on each side of the said gate. This embodiment further involves attaching three labels to each gate, the first representing the orientation (vertical (V), horizontal (H)), and two labels referring to the distance to neighbors on each side. The label for a vertical gate would be VXY, where X and Y correspond to the distance to the neighbors to the east and west, respectively. The label for a horizontal gate would be HXY, where X and Y correspond to the distance to the neighbors to the north and south, respectively. The directions, east, west, north, and south, as used herein, are defined with respect to the flat of the wafer 401, and are not intended to suggest any particular absolute orientation with respect to external objects. This embodiment of the labeling method assigns numbers corresponding to distances. In particular, “1” refers to the smallest distance, “2” refers to an intermediate distance, and “3” refers to a large distance. Gate 402 is labeled V32; gate 403 is labeled V22; gate 404 is labeled V23; gate 405 is labeled H32; gate 406 is labeled 121; and gate 407 is labeled H13. Other labeling methods and descriptions of the neighborhood may be used to practice the present invention, as would be apparent to one of ordinary skill in the art from the description herein.

The present invention utilizes the following solution to the problem of the interaction of spatial (intra-field) variation and local, layout pattern-dependent variation: the topological (spatial) CD maps are generated for each gate category individually, and then applied to determine the correction profile.

Given a classification system, CD data for each gate category in different positions throughout the optical field may be collected via any method known to those skilled in the art, from which CD maps are generated. The generation of CD maps may involve interpolation between the data points.

In order to save effort, one embodiment of the current invention involves limiting the number of gate categories for which data is collected. In this case data is only collected for those categories that are most frequent in the layout of an IC product. Mask correction for the said IC product is then limited to only these most frequent categories.

B. Mask (Layout) Correction

Mask-level CD correction is a powerful mechanism to improve CD control, which is beneficial to both performance and yield. Optical proximity correction algorithms have been used for a long time. They are based on the idea of compensating for the known systematic non-idealities of an optical system by modifying a mask (layout) in an appropriate manner. So far, correction has been used to compensate for line end shortening and comer rounding. The present invention significantly enhances the existing correction algorithms by introducing several new features. First, spatial variation of CD across the optical field, and its interaction with local pattern-dependent variation, is corrected. Second, bias due to a gate's neighborhood is corrected. Correction is done not only for bias due to the relative spacing of gates, but also distinguishing gates with neighbors to the east vs. west, and vertical vs. horizontal orientations of gates.

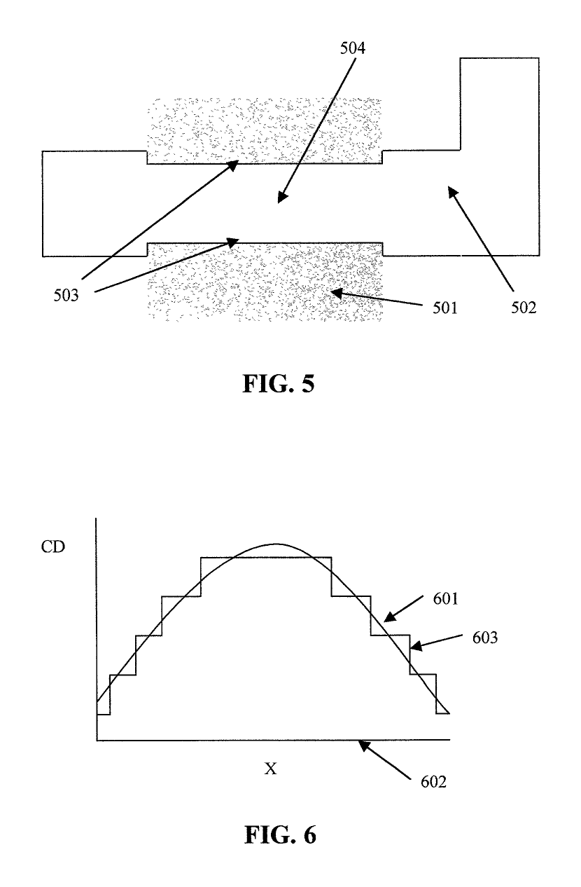

Mask correction involves increasing or reducing the width of the lines in the gate layer mask, to compensate for variations of CDs on the wafers. In other words, if the CD is too large in a given area of the wafer, then the corresponding line on the mask is made smaller. Correction can be applied to all lines or just to the transistors. Referring to FIG. 5, a transistor 504 is formed when the active layer 501 intersects with the gate layer 502. Correction 503 is applied to only the gate area in this example.

In the preferred embodiment of the invention, both spatial CD and category-specific CD data are used to determine the correction scheme. For this embodiment the category-specific CD maps are used to generate the correction profile. This way, the interaction between the global variation due to lens aberrations and local pattern-dependent variation, found to be significant, is taken into account during correction. The present invention, however, does not depend on the use of both spatial and category-specific data. A mask correction scheme can be designed which involves either spatial or category-specific data.

The following steps are carried out when applying correction, after generating the category-specific topological CD maps.

First, the CD maps are converted to a set of mask correction profiles. The relation between the mask correction amounts and CD is usually modeled as a linear shift, and the value of the shift is determined by the relationship of the line widths on the mask to the CDs of the lines that they were used to generate. There may be a nonlinear relationship between changes on the mask and the resulting CDs. If this is the case, this nonlinear relationship is easily incorporated during the generation of the final mask correction profile.

Second, the mask correction resolution, R, must be chosen. For practical reasons, due to limitations of the mask-making equipment, mask resolution cannot be arbitrarily small. Increasing mask resolution is costly. In addition, since a component of gate CD variation is random, correcting by any amount smaller than the random variation within the optical field of the gate CD is likely to be ineffective. Hence, applying a very high resolution mask correction scheme may lead to diminishing returns in terms of variation reduction and would not be justified from the economic standpoint. In general, there is an optimum value of resolution that balances benefits of correction and the cost of making the mask.

Third, the mask correction profiles are discretized, for each gate category, as a function of position within the field. The discretization involves rounding the mask correction value, at any point in the optical field, to the nearest value, n*R, where n is an integer. FIG. 6 shows an example of a one-dimensional mask correction profile 601 as a function of position within an optical field 602 and its discretization 603 based on the chosen mask correction resolution.

Fourth, the layout is a representation of the mask, but it may be scaled and modified before generating the mask. Hence, an equation is needed to translate mask correction amounts, into the changes in the widths of features to be applied to the layout. The method for determining such an equation would be apparent to one of ordinary skill in the art.

Finally, the discretized mask correction amounts are applied to a product layout. The layout is fed into a software tool that determines the spatial location of a particular gate both within the chip, and within the optical field, given the placement of the chip in the optical field. The software tool also classifies the gate, reads the correction amount from the corresponding discretized correction profile, and modifies the gate in the layout by this amount.

Several variants of the above method are possible. First, operating on a layout in flat form is very computationally intensive. One embodiment of the present invention would involve operating on a layout block by block. In fact, many layouts are stored in a hierarchical form, making it possible to determine a natural partition of the layout by block. The main drawback of this approach is that gates on the edges of the blocks may not be properly corrected, since their neighborhood is not completely known. Instead, assumptions are made about the features in the neighboring blocks to determine the correction amounts for the said edge gates.

Second, collecting data for all gate categories may not be practical if the number of gate categories is large. Instead, one embodiment of the current invention involves limiting the number of gate categories for which data is collected to only those categories that are most frequent in the product layout. Mask correction amounts for rare gate categories are determined by either interpolation from nearby categories, grouping with nearby categories, or, possibly, no correction is applied at all for such rare categories.

Third, an optical field contains one or more ICs. The embodiment of the invention described above would apply different correction amounts to each of the ICs, depending on their location in the optical field. Such an approach could be computationally intensive, since the required work for applying mask correction would be proportional to the number of chips per optical field. To save effort, one embodiment of the current invention determines a single set of mask correction amounts for the design, determined by averaging correction amounts for each of the instances of the chip in the optical field, at each point within the chip layout, to determine the spatial correction profile for the chip.

Fourth, a further embodiment of the invention involves limiting the spatial correction resolution to a single set of correction amounts for each gate category for each instance of a chip in the optical field. Such an embodiment would simplify the requirements for the software tool that applies the mask correction algorithm to the design, since the step involving looking up the location of each transistor within the optical field is avoided. Instead, only correction by category is applied to the layout, although a different set of corrections would be applied as a function of the location of the chip within the optical field.

C. Analysis of Mask Correction Schemes

The achievable variability reduction depends on the mask correction resolution, R, the range of intra-field CD variation, Rf, the completeness of the CD sampling plan, and the inter-field variance, σ. Clearly, a more comprehensive sampling plan (the number of CD measurement points per field and gate categories) and a finer mask resolution leads to better correction. In order to determine the effectiveness of a mask correction scheme, one could apply the correction amounts to the CD data set to evaluate the improvement in uniformity of the CD. Such an approach is complicated by the fact the circuit designs are dominated by very few gate categories. Therefore, when calculating the improvement in uniformity, it is important to work with weighted averages so that the uniformity calculation reflects the frequency of gates in the product design. However, if the purpose is to determine the relationship between mask resolution and improvement in CD uniformity a simpler approach is possible. In other words, assuming some basic linear properties of the shape of the CD profile, the ratio between the overall raw and corrected variances may be approximated as:

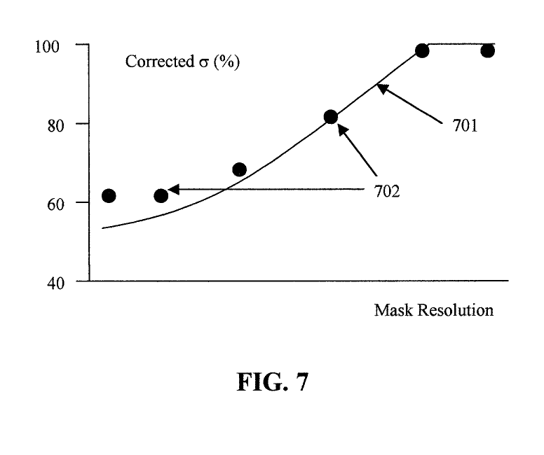

(12*σ*σ+R*R)/(12*σ*σ+Rf*Rf)

where Rf=max(CD(x,y))−min(CD(x,y)), σ is the standard deviation of the noise due to inter-field variability, and CD(x,y) is the CD profile over the optical field. Referring to FIG. 7, the model shows good agreement between the model 701 and the model-free data 702 generated by applying the correction algorithm to the actual data.

Reduction in CD variation is also influenced by the completeness of the spatial measurement plan and the number of gate categories for which measurements are collected. Clearly, to achieve the best possible reduction in intra-field CD variation, the precise shape of the category-specific CD maps is required, which means that a sufficient number of repeated measurements have to be carried out over the surface of the optical field. Uncertainty about the CD profile leads to less effective mask correction, and possibly increased non-uniformity of the gate CD compared to when no mask correction is applied at all. Similarly, if data is collected for too few gate categories, or alternatively, the less frequent gate categories, the resulting uncertainty in the CD profile for the missing gate categories also leads to less effective mask correction. The current invention includes a method to analyze the completeness of the sampling plan and the set of gate categories, which involves applying the correction amounts to the CD data set to evaluate the improvement in uniformity of the CD, weighting the gate category data according to the frequency of the said category in the layout.

The invention is limited only as defined in the following claims and equivalents thereof.

We claim:

1. A method to modify the layout of a circuit prior to mask creation, before or after the application of optical proximity correction to the layout, if used, to ensure greater uniformity of the gate CD, said method involving the steps of:
A. feeding the layout of the “gate layer” into a software tool that looks up the spatial location of each feature in the chip and in the optical field; and
B. increasing or decreasing, according to a predefined spatial map of correction amounts as a function of position in the optical field, the widths of all polysilicon (or whatever layer is used in the layout to represent the gates of transistors) lines in a layout as a function of position of the chip within the optical field and each specific feature within the chip.

2. A method to modify the layout of a circuit prior to mask creation, before or after the application of optical proximity correction to the layout, if used, to ensure greater uniformity of the gate CD, said method involving the steps of:
A. feeding the layout into a software tool to identify the transistors and to look up the spatial location of each transistor gate in the chip and in the optical field; and
B. increasing or decreasing, according to a predefined spatial map of correction amounts as a function of position in the optical field, the widths of the portions of polysilicon (or whatever layer is used in the layout to represent the gates of transistors) lines used to form transistors as a function of position of the chip within the optical field and each specific gate within the chip.

3. A method to modify the layout of a circuit prior to mask creation, before or after the application of optical proximity correction to the layout, if used, to ensure greater uniformity of the gate CD, said method involving the steps of:
A. feeding the layout into a software tool to identify the transistors and the category of each transistor; and
B. increasing or decreasing, according to a predefined set of correction amounts for each transistor category, the widths of all polysilicon (or whatever layer is used in the layout to represent the gates of transistors) lines used to form transistors as a function of the classification of the gate according to any or all of the following features: (i) orientation (for example, but not limited to vertical, horizontal, 45 degree orientations), (ii) neighborhood of features in the same layer of the layout (for example, but not limited to distance to nearest neighbors and more distant neighbors and/or a complete description of the neighborhood, as defined by a physical distance to other features), and (iii) the relative position of neighboring structures is the same layer of the layout (for example, east vs. west neighbors, north vs. south neighbors, and/or a complete description of the neighborhood, as defined by physical distance and location of adjacent structures with respect to each said gate).

4. A method to modify the layout of a circuit prior to mask creation, before or after the application of optical proximity correction to the layout, if used, to ensure greater uniformity of the gate CD, said method involving the steps of:
A. feeding the layout into a software tool to identify the transistors, the category of each transistor, and the location of each transistor within the chip and within the optical field; and
B. increasing or decreasing, according to a predefined set of spatial maps of correction amounts as a function of position within the optical field, the widths of the portions of polysilicon (or whatever layer is used to represent the gates of transistors) lines used to form transistors as a function of the position of the chip within the optical field and each specific gate within the chip and as a function of the classification of the gate according to any or all of the following features: (i) orientation (for example, but not limited to vertical, horizontal, 45 degree orientations), (ii) neighborhood of features in the same layer of the layout (for example, but not limited to distance to nearest neighbors and more distant neighbors and/or a complete description of the neighborhood, as defined by a physical distance to other features), and (iii) the relative position of neighboring structures in the same layer of the layout (for example, east vs. west neighbors, north vs. south neighbors, and/or a complete description of the neighborhood, as defined by physical distance and location of adjacent structures with respect to each said gate).

5. A method to modify the layout of a circuit prior to mask creation, before or after the application of optical proximity correction to the layout, if used, to ensure greater uniformity of the gate CD, said method involving the steps of:
A. feeding the layout, one block at a time, into a software tool to identify the transistors and the category of each transistor, where, for transistors near the edges of the blocks, a set of patterns outside the block are assumed; and
B. block by block, increasing or decreasing, according to a predefined set of correction amounts for each transistor category, the widths of all polysilicon (or whatever layer is used in the layout to represent the gates of transistors) lines used to form transistors as a function of the classification of each of the gates within the block, according to any or all of the following features: (i) orientation (for example, but not limited to vertical, horizontal, 45 degree orientations), (ii) neighborhood of features in the same layer of the layout (for example, but not limited to distance to nearest neighbors and more distant neighbors and/or a complete description of the neighborhood, as defined by a physical distance to other features), and (iii) the relative position of neighboring structures in the same layer of the layout (for example, east vs. west neighbors, north vs. south neighbors, and/or a complete description of the neighborhood, as defined by physical distance and location of adjacent structures with respect to each said gate).

6. A method to modify the layout of a circuit prior to mask creation, before or after the application of optical proximity correction to the layout, if used, to ensure greater uniformity of the gate CD, said method involving the steps of:
A. feeding the layout, one block at a time, into a software tool to identify transistors, the category of each transistor, and the location of each transistor within the chip and within the optical field; and
B. block by block, increasing or decreasing, according to a predefined set of spatial maps of correction amounts as a function of position in the optical field, the widths of the portions of polysilicon (or whatever layer is used to represent the gates of transistors) lines used to form transistors as a function of the position of the chip within the optical field and each specific gate within the chip and as a function of the classification of each of the gates within the block and as a function of assumed patterns outside the block, according to any or all of the following features: (i) orientation (for example, but not limited to vertical, horizontal, 45 degree orientations), (ii) neighborhood of features in the same layer of the layout (for example, but not limited to distance to nearest neighbors and more distant neighbors and/or a complete description of the neighborhood, as defined by a physical distance to other features), and (iii) the relative position of neighboring structures in the same layer of the layout (for example, east vs. west neighbors, north vs. south neighbors, and/or a complete description of the neighborhood, as defined by physical distance and location of adjacent structures with respect to each said gate).

7. The method for computing mask correction amounts and applying mask correction comprising the steps of:
A. finding CD on the wafer as a function of position within the optical field: CD(x,y), by any method as would be determined by one skilled in the art;
B. determining the relationship between changes on the mask and changes reflected on the wafer, through constructing a function relating two or more widths of lines on the mask, W, to the corresponding CD measurements on the wafer, W=f(CD), where f() denotes the said function;
C. computing mask correction amounts (positive correction amounts increase the width of the lines on the mask by the said amount) as a constant (used to set the mean line width on the mask) minus the function computed in step B, applied to the CD map from step A:
−1*f(CD(x,y))+constant;
D. selecting a resolution, R, greater than equal to zero, to define a set of possible correction amounts, n*R, where n is an integer;
E. discretizing the mask correction amounts by rounding the correction amounts computed in step C to the closest value, n*R, for each point in the optical field (x,y);
F. determining the relationship between changes in the widths of lines in the layout and changes on the mask, and translating the discretized mask correction amounts to layout correction amounts; and
G. applying mask correction to the layout utilizing the method of claim 1 or 2 and the layout correction amounts of step F.

8. The method of for computing mask correction amounts and applying mask correction comprising the steps of:
A. finding CD on the wafer as a function of the classification of the gates: CD(cat), by any method as would be determined by one skilled in the art;
B. determining the relationship between changes on the mask and changes reflected on the wafer, through constructing a function relating two or more widths of lines on the mask, W, to the corresponding CD measurements on the wafer, W=f(CD), where f() denotes the said function;
C. computing mask correction amounts (positive correction amounts increase the width of the lines on the mask by the said amount) as a constant (used to set the mean line width on the mask) minus the function computed in step B, applied to the CD data, computed as a function of category from step A:
−1*f(CD(cat))+constant;
D. selecting a resolution, R, greater than equal to zero, to define a set of possible correction amounts, n*R, where n is an integer;
E. discretizing the mask correction amounts rounding the correction amounts computed in step C to the closest value, n*R, for each transistor category, cat;
F. determining the relationship between changes in the widths of lines in the layout and changes on the mask, and translating the discretized mask correction amounts to the layout correction amounts; and
G. applying mask correction to the layout utilizing the method of claim 3 or 5 and the layout correction amounts of step F.

9. The method for computing mask correction amounts and applying mask correction comprising the steps of:
A. finding CD on the wafer as a function of both the position within the optical field and the classification of gates, to compute CD(x,y,cat), by any method as would be determined by one skilled in the art;
B. determining the relationship between changes on the mask and changes reflected on the wafer, through constructing a function relating two or more widths of lines on the mask, W, to the corresponding CD measurements on the wafer, W=f(CD), where f() denotes the said function;
C. computing mask correction amounts (positive correction amounts increase the width of the lines on the mask by the said amount) as a constant (used to set the mean line width on the mask) minus the function computed in step B, applied to the CD data from step A:
−1*f(CD(x,y,cat))+constant;
D. selecting a resolution, R, greater than equal to zero, to define a set of possible correction amounts, n*R, where n is an integer;
E. discretizing the mask correction amounts by rounding the correction amounts computed in step C to the closest value, n*R, for each point in the optical field (x,y) and each category, cat;
F. determining the relationship between changes in the widths of the lines in the layout and changes on the mask, and translating the discretized mask correction amounts to layout correction amounts; and
G. applying mask correction to the layout utilizing the method of claim 4 or 6 and the layout correction amounts of step F.

10. The method for computing mask correction amounts and applying mask correction comprising the steps of:
A. selecting only the most frequent categories in a layout for mask correction;
B. finding CD on the wafer for the selected categories of step A as a function of the classification of the gates: CD(cat), by any method as would be determined by one skilled in the art;
C. determining the relationship between changes on the mask and changes reflected on the wafer, through constructing a function relating two or more widths of lines on the mask, W, to the corresponding CD measurements on the wafer, W=f(CD), where f() denotes the said function;
D. computing mask correction amounts (positive correction amounts increase the width of the lines on the mask by the said amount) as a constant (used to set the mean line width on the mask) minus the function computed in step C, applied to the CD data, computed as a function of category from step B:
−1*f(CD(cat))+constant;
E. selecting a resolution, R, greater than equal to zero, to define a set of possible correction amounts, n*R, where n is an integer;
F. discretizing the mask correction amounts by rounding the correction amounts computed in step D to the closest value, n*R, for each transistor category, cat, while selecting correction amounts for the missing categories by any method as would be determined by one skilled in the art;
G. determining the relationship between changes in the widths of lines in the layout and changes on the mask, and translating the discretized mask correction amounts to layout correction amounts; and
H. applying mask correction to the layout utilizing the method of claim 3 or 5 and the layout correction amounts of step G.

11. The method for computing mask correction amounts and applying mask correction comprising the steps of:
A. selecting only the most frequent categories in a layout for mask correction;
B. finding CD on the wafer for the selected categories of step A as a function of both the position within the optical field and the classification of gates, to compute CD(x,y,cat), by any method as would be determined by one skilled in the art;
C. determining the relationship between changes on the mask and changes reflected on the wafer, through constructing a function relating two or more widths of lines on the mask, W, to the corresponding CD measurements on the wafer, W=f(CD), where f() denotes the said function;
D. computing mask correction amounts (positive correction amounts increase the width of the lines on the mask by the said amount) as a constant (used to set the mean line width on the mask) minus the function computed in step C, applied to the CD data from step B:
−1*f(CD(x,y,cat))+constant;
E. selecting a resolution, R, greater than equal to zero, to define a set of possible correction amounts, n*R, where n is an integer;
F. discretizing the mask correction amounts by rounding the correction amounts computed in step D to the closest value, n*R, for each point in the optical field (x,y) and each category, cat, while selecting correction amounts for the missing categories by any method as would be determined by one skilled in the art;
G. determining the relationship between changes in the widths of lines in the layout and changes on the mask, and translating the discretized mask correction amounts to layout correction amounts; and
H. applying mask correction to the layout utilizing the method of claim 4 or 6 and the layout correction amounts of step G.

12. The method for computing mask correction amounts and applying mask correction comprising the steps of:
A. finding CD on the wafer as a function of position within the optical field, CD(x,y), by any method as would be determined by one skilled in the art;
B. determining the relationship between changes on the mask and changes reflected on the wafer, through constructing a function relating two or more widths of lines on the mask, W, to the corresponding CD measurements on the wafer, W=f(CD), where f() denotes the said function;
C. computing mask correction amounts (positive correction amounts increase the width of the lines on the mask by the said amount) as a constant (used to set the mean line width on the mask) minus the function computed in step B, applied to the CD map from step A:
−1*f(CD(x,y))+constant;
D. partitioning the optical field into areas, each associated with each copy of a chip (die), where each location in the chip is labeled with its own coordinate system, (p,q), with respect to a specific point in the die, such that x=p+constant 1 and y=q+constant 2, where constant 1 and constant 2 are a function of the location of the chip within the optical field;
E. computing modified mask correction amounts for the said chip design (layout) by averaging correction amounts determined in step C over each chip location within the optical field (all data with the same values of p,q is averaged) to find a single set of correction amounts as a function of position in the layout:
−1*f(CD(p,q))+constant;
F. selecting a resolution, R, greater than equal to zero, to define a set of possible correction amounts, n*R, where n is an integer;
G. discretizing the mask correction amounts by rounding the correction amounts computed in step E to the closest value, n*R, for each point in the chip (p,q);
H. determining the relationship between changes in the widths of lines in the layout and changes on the mask, and translating the discretized mask correction amounts to layout correction amounts; and
I. applying mask correction to the layout utilizing the method of claim 1 or 2 and the layout correction amounts of step H.

13. The method for computing mask correction amounts and applying mask correction comprising the steps of:
A. finding CD on the wafer as a function of both the position within the optical field and the classification of gates, to compute CD(x,y,cat), by any method as would be determined by one skilled in the art;
B. determining the relationship between changes on the mask and changes reflected on the wafer, through constructing a function relating two or more widths of lines on the mask, W, to the corresponding CD measurements on the wafer, W=f(CD), where f() denotes the said function;
C. computing mask correction amounts (positive correction amounts increase the width of the lines on the mask by the said amount) as a constant (used to set the mean line width on the mask) minus the function computed in step B, applied to the CD data from step A:
−1*f(CD(x,y,cat))+constant;
D. partitioning the optical field into areas, each associated with each copy of a chip (die), where each location in the chip is labeled with its own coordinate system, (p,q), with respect to a specific point in the die, such that x=p+constant 1 and y=q+constant 2, where constant 1 and constant 2 are a function of the location of the chip within the optical field;
E. computing modified mask correction amounts for the said chip design (layout) by averaging correction amounts determined in step C over each chip location within the optical field (all data with the same values of p,q are averaged), to find a single set of correction amounts as a function of position within the layout:
−1*f(p,q,cat))+constant;
F. selecting a resolution, R, greater than equal to zero, to define a set of possible correction amounts, n*R, where n is an integer;
G. discretizing the mask correction amounts by rounding the correction amounts computed in step E to the closest value, n*R, for each point in the chip (p,q);
H. determining the relationship between changes in the widths of lines in the layout and changes on the mask, and translating the discretized mask correction amounts to layout correction amounts; and
I. applying mask correction to the layout utilizing the method of claim 4 or 6 and the layout correction amounts of step H.

14. The method for computing mask correction amounts and applying mask correction comprising the steps of:
A. selecting only the most frequent categories in a layout for mask correction;
B. finding CD on the wafer as a function of both the position within the optical field and the classification of gates, for the gate categories selected in step A, to compute CD(x,y,cat), by any method as would be determined by one skilled in the art;
C. determining the relationship between changes on the mask and changes reflected on the wafer, through constructing a function relating two or more widths of lines on the mask, W, to the corresponding CD measurements on the wafer, W=f(CD), where f() denotes the said function;
D. computing mask correction amounts (positive correction amounts increase the width of the lines on the mask by the said amount) as a constant (used to set the mean line width on the mask) minus the function computed in step C, applied to the CD data from step B:
−1*f(CD(x,y,cat))+constant;
E. partitioning the optical field into areas, each associated with each copy of a chip (die), where each location in the chip is labeled with its own coordinate system, (p,q), with respect to a specific point in the die, such that x=p+constant 1 and y=q+constant 2, where constant 1 and constant 2 are a function of the location of the chip within the optical field;
F. computing modified mask correction amounts for the said chip design (layout) by averaging correction amounts determined in step D over each chip location within the optical field (all data with the same values of p,q are averaged), to find a single set of correction amounts as a function of position within the layout:
−1*f(p,q,cat))+constant;
G. selecting a resolution, R, greater than equal to zero, to define a set of possible correction amounts, n*R, where n is an integer;
H. discretizing the mask correction amounts by rounding the correction amounts computed in step F to the closest value, n*R, for each point in the chip (p,q), while selecting other correction amounts for the missing categories by any method as would be determined by one skilled in the art;
I. determining the relationship between changes in the widths of lines in the layout and changes on the mask, and translating the discretized mask correction amounts to layout correction amounts; and
J. applying mask correction to the layout utilizing the method of claim 4 or 6 and the layout correction amounts of step I.

15. The method for computing mask correction amounts and applying mask correction comprising the steps of:
A. finding CD on the wafer as a function of position within the optical field: CD(x,y), by any method as would be determined by one skilled in the art;
B. determining the relationship between changes on the mask and changes reflected on the wafer, through constructing a function relating two or more widths of lines on the mask, W, to the corresponding CD measurements on the wafer, W=f(CD), where f() denotes the said function;
C. computing mask correction amounts (positive correction amounts increase the width of the lines on the mask by the said amount) as a constant (used to set the mean line width on the mask) minus the function computed in step B, applied to the CD map from step A:
−1*f(CD(x,y))+constant;
D. partitioning the optical field into areas, each associated with each copy of a chip (die);
E. computing modified mask correction amounts for each chip having a different location in the optical field by averaging correction amounts determined in step C for each of the areas defined in step D, such that correction amounts only change values between chips;
F. selecting a resolution, R, greater than equal to zero, to define a set of possible correction amounts, n*R, where n is an integer;
G. discretizing the mask correction amounts by rounding the correction amounts computed in step E to the closest value, n*R, for each point in the optical field (x,y);
H. determining the relationship between the changes in the widths of lines in the layout and changes on the mask, and translating the discretized mask correction amounts to layout correction amounts; and
I. applying mask correction to the layout utilizing the method of claim 1 or 2 and the layout correction amounts of step H.

16. The method for computing mask correction amounts and applying mask correction comprising the steps of:
A. finding CD on the wafer as a function of both the position within the optical field and the classification of gates, to compute CD(x,y,cat), by any method as would be determined by one skilled in the art;
B. determining the relationship between changes on the mask and changes reflected on the wafer, through constructing a function relating two or more widths of lines on the mask, W, to the corresponding CD measurements on the wafer, W=f(CD), where f() denotes the said function;
C. computing mask correction amounts (positive correction amounts increase the width of the lines on the mask by the said amount) as a constant (used to set the mean line width on the mask) minus the function computed in step B, applied to the CD data from step A:
−1*f(CD(x,y,cat))+constant;
D. partitioning the optical field into areas, each associated with each copy of a chip (die);
E. computing modified mask correction amounts for each chip having a different location in the optical field by averaging correction amounts determined in step C for each of the areas defined in step D, such that correction amounts only change values between chips;
F. selecting a resolution, R, greater than equal to zero, to define a set of possible correction amounts, n*R, where n is an integer;
G. discretizing the mask correction amounts by rounding the correction amount computed in step E to the closest value, n*R, for each point in the optical field (x,y) and for each gate category, cat;
H. determining the relationship between changes in the widths of lines in the layout and changes on the mask, and translating the discretized mask correction amounts to layout correction amounts; and
I. applying mask correction to the layout utilizing the method of claim 4 or 6 and layout correction amounts of step H.

17. The method for computing mask correction amounts and applying mask correction comprising the steps of:
A. selecting only the most frequent categories in a layout for mask correction;
B. finding CD on the wafer as a function of both the position within the optical field and the classification of gates, for the gate categories selected in step A, to compute CD(x,y,cat), by any method as would be determined by one skilled in the art;
C. determining the relationship between changes on the mask and changes reflected on the wafer, through constructing a function relating two or more widths of lines on the mask, W, to the corresponding CD measurements on the wafer, W=f(CD), where f() denotes the said function;
D. computing mask correction amounts (positive correction amounts increase the width of the lines on the mask by the said amount) as a constant (used to set the mean line width on the mask) minus the function computed in step C, applied to the CD data from step B:
−1*f(CD(x,y,cat))+constant;
E. partitioning the optical field into areas, each associated with each copy of a chip (die);
F. computing modified mask correction amounts for each chip having a different location in the optical field by averaging correction amounts determined in step D for each of the areas defined in step E, such that correction amounts only change values between chips;
G. selecting a resolution, R, greater than equal to zero, to define a set of possible correction amounts, n*R, where n is an integer;
H. discretizing the mask correction amounts by rounding the correction amount computed in step F to the closest value, n*R, for each point in the optical field (x,y) and for each gate category, cat, while selecting other mask correction amounts for the missing categories by any method as would be determined by one skilled in the art;
I. determining the relationship between changes in the widths of lines in the layout and changes on the mask, and translating the discretized mask correction amounts to layout correction amounts; and
J. applying mask correction to the layout utilizing the method of claim 4 or 6 and the layout correction amounts of step I.

18. A method to estimate the impact of mask correction on gate CD uniformity across the optical field, said method including the steps of:
A. fabricating a collection of wafers, and collecting CD data as a function of position within the optical field (x,y), indexed by field, CD(x,y,field,i), using a mask where the line width of features on the mask used to create the lines from which CD is measured is fixed, by performing measurements of CD over multiple optical fields, by any method as would be determined by one skilled in the art;
B. averaging the CD over each optical field, aveCD(field), and calculating the CD differences,
CD′(x,y,I)=CD(x,y,field,i)−aveCD(field)
to create a new data set;
C. computing the standard deviation, σ′ of the dataset CD′(x,y,i) created in step B;
D. determining the relationship between changes on the mask and changes reflected on the wafer, through constructing a function relating two or more widths of lines on the mask, W, to the corresponding CD measurements on the wafer, CD=g(W), where g() denotes the said function, and finding its derivative at nominal line width on the mask, i.e. ΔCD=h(W′)*ΔW, h() denotes the said derivative function and W′ denotes the nominal line width on the mask;
E. determining mask correction amounts Z(x,y) by either the methods of claims 7, 12, or 15, or any other spatial mask correction method apparent to one of ordinary skill in the art;
F. computing the changes in CD, corresponding to the mask correction scheme of step D, using the derivative function determined in step D, i.e.
deltaCD(x,y)=h(W′)*Z(x,y);
G. computing a new data set of expected CD differences from the original data set, CD′, as
CD″(x,y,i)=CD′(x,y,i)+h(W′)*Z(x,y);
and
H. computing the standard deviation, σ″, of the new data set, CD″(x,y,i), where the ratio between σ′ and σ″ provides an indication of improvement from mask correction for a given mask correction resolution.

19. A method to estimate the impact of mask correction on gate CD uniformity across the optical field, said method including the steps of:
A. fabricating a collection of wafers, and collecting CD data as a function of position within the optical field, CD(x,y,i), using a mask where the line width of features on the mask used to create the lines from which CD is measured is fixed, by performing measurements of CD over multiple optical fields, by any method as would be determined by one skilled in the art;
B. computing a “CD map,” CD(x,y), by averaging data at each site of the optical field and possibly using an interpolation procedure if data is missing;
C. computing a modified data set, eliminating variation across the field:
InterField(x,y,i)=CD(x,y,i)−CD(x,y);
D. computing the standard deviation, σ, of the modified data set computed in step C, InterField(x,y,i);
E. computing the range of CD variation within the optical field:
Rf=max(CD(x,y))−min(CD(x,y));
and
F. estimating the expected ratio between the standard deviation after correction to the standard deviation before correction for a mask correction method of resolution R (which defines the set of possible correction amounts, n*R, where n is an integer) as
square-root((12*σ*σ+R*R)/(12*σ*σ+Rf*Rf)),
which provides an indication of improvement from mask correction.

20. A method to estimate the impact of mask correction on gate CD uniformity, across the optical field, given a collection of gates with a variety of orientations and neighboring features, said method including the steps of:
A. labeling all gates of a layout or on a wafer to specify their category (cat) by any or all of the following criteria: (i) orientation (for example, vertical or horizontal), (ii) neighboring features within the same layer of the layout (for example, but not limited to the distance to nearest neighbors and/or more distant neighbors), and (iii) relative positions of neighboring structures within the same layer of the layout (for example, but not limited to east vs. west neighbors, north vs. south neighbors);
B. determining a weighting function, weight(cat), associated with each of the categories, usually associated with, but not necessarily limited to, the frequency of each of the categories in a layout of a target circuit;
C. fabricating a collection of wafers, and collecting CD data as a function of the classification of the gate and possibly the position within the optical field (x,y), indexed by field, CD(x,y,cat,field,i), using a mask where the line width of features on the mask used to create the lines from which CD is measured is fixed, by performing measurements of CD over multiple instances of each gate category and over multiple optical fields, by any method as would be determined by one skilled in the art;
D. averaging the CD over each optical field, aveCD(field) and calculating the CD differences,
CD′(x,y,cat,i)=CD(x,y,cat,field,i)−aveCD(field)
to create a new data set.
E. computing a weighted mean CD′ value, based on the weighting function of step B: mean(CD′);
F. computing the weighted variance which is the weighted sum of the variances associated with each category plus the weighted sum of the squares of the difference between the global mean, mean(CD′), and the category mean: Var(CD′);
G. computing the standard deviation, σ′, by taking the square root of Var(CD′);
H. determining the relationship between changes on the mask and changes reflected on the wafer, through constructing a function relating two or more widths of lines on the mask, W, to the corresponding CD measurements on the wafer, CD=g(W), where g() denotes the said function, and finding its derivative at nominal line width on the mask, i.e. ΔCD=h(W′)*ΔW, where h() denotes the said derivative function and W′ denotes the nominal line width on the mask;
I. determining mask correction amounts Z(x,y,cat) by either the method of claim 8, 9, 10, 11, 13, 14, 16, or 17 or any other mask correction method apparent to one of ordinary skill in the art;
J. computing the changes in CD, corresponding to the mask correction scheme of step I, using the derivative finction determined in step H, i.e.
deltaCD(x,y,cat)=h(W′)*Z(x,y,cat);
K. computing a new data set of expected CD differences from the original data set, CD′, as
CD″(x,y,cat,i)=CD′(x,y,cat,i)+h(W′)*Z(x,y,cat);
L. computing a weighted mean CD″ value of the new data set, based on the weighing function of step B: mean(CD″);
M. computing the weighted variance which is the weighted sum of the variances associated with each category in the new dataset plus the weighted sum of the squares of the difference between the global mean, mean(CD″), computed in step L, and the category mean for each category in the new data set, to be labeled Var(CD″);
N. computing the standard deviation, σ″, of the new data set, by taking the square root of Var(CD″), where the ratio between σ′ and σ″ provides an indication of improvement from mask correction.

21. A method to estimate the impact of the sampling of CD across the optical field, for the purpose of generating a mask correction scheme on gate CD uniformity, said method including the steps of:
A. fabricating a collection of wafers, and collecting CD data as a function of position within the optical field (x,y), indexed by optical field, CD(x,y,field,i), using a mask where the line width of features on the mask used to create the lines from which CD is measured is fixed, by performing measurements of CD over multiple optical fields, by any method as would be determined by one skilled in the art;
B. averaging the CD over each optical field, aveCD(field), and calculating the CD difference,
CD′(x,y,i)=CD(x,y,field,i)−aveCD(field)
to create a new data set;
C. computing the standard deviation, σ of the dataset CD′(x,y,i);
D. determining the relationship between changes on the mask and changes reflected on the wafer, through constructing a finction relating two or more widths of lines on the mask, W, to the corresponding CD measurements on the wafer, CD=g(W), where g() denotes the said function, and finding its derivative at nominal line width on the mask, i.e. ΔCD=h(W′)*ΔW, h() denotes the said derivative function and W′ denotes the nominal line width on the mask;
E. selecting various subsets of the data set CD′(x,y,i) containing a limited set of positions (x,y) in the optical field and determining mask correction amounts Z(x,y,sample) using this limited data set by either the methods of claims 7, 12, or 15, or any other spatial mask correction method apparent to one of ordinary skill in the art;
F. computing the changes in CD, for each of the mask correction schemes generated in step E, using the derivative function determined in step D, i.e.
deltaCD(x,y, sample)=h(W′)*Z(x,y,sample);
G. computing a new data set of expected CD differences from the original data set, CD′(sample), for each of the mask correction schemes generated in step E, as
CD″(x,y,i,sample)=CD′(x,y,i)+h(W′)*Z(x,y,sample);
and
H. computing the standard deviation, σ″(sample), of each of the new data sets, CD″(x,y,i,sample), where the ratio between σ′ and σ″(sample) provides an indication of improvement from mask correction achieved for each spatial sampling scheme and for a given mask correction resolution.

22. A method to estimate the impact of limiting the number of categories in mask correction and/or the number of positions within the optical field where CD is measured on gate CD uniformity, given a collection of gates with a variety of orientations and neighboring features and in different positions in the optical field, said method including the steps of:
A. labeling all gates of a layout or on a wafer to specify their category (cat) by any or all of the following criteria: (i) orientation (for example, vertical or horizontal), (ii) neighboring features within the same layer of the layout (for example, but not limited to the distance to nearest neighbors and/or more distant neighbors), and (iii) relative positions of neighboring structures within the same layer of the layout (for example, but not limited to east vs. west neighbors, north vs. south neighbors);
B. determining a weighting ftunction, weight(cat), associated with each of the categories, where the weighting function is usually associated with, but not necessarily limited to, the frequency of each of the categories in a layout of a target circuit;
C. fabricating a collection of wafers, and collecting CD data as a function of position in the optical field (x,y) and the classification of the gate, indexed by optical field, CD(x,y,cat,field,i), using a mask where the line width of features on the mask used to create the lines from which CD is measured is fixed, by performing measurements of CD over multiple optical fields and instances of each gate category, by any method as would be determined by one skilled in the art;
D. averaging the CD over each optical field, aveCD(field) and calculating the CD differences,
CD′(x,y,cat,i)=CD(x,y,cat,field,i)−aveCD(field)
to create a new data set;
E. computing a weighted mean CD′ value, based on the weighting function of step B: mean(CD′);
F. computing the weighted variance which is the weighted sum of the variances associated with each category plus the weighted sum of the squares of the difference between the global mean, mean(CD′), and the category mean: Var(CD′);
G. computing the standard deviation, σ′, by taking the square root of Var(CD′);
H. determining the relationship between changes on the mask and changes reflected on the wafer, through constructing a function relating two or more widths of lines on the mask, W, to the corresponding CD measurements on the wafer, CD=g(W), where g() denotes the said function, and finding its derivative at nominal line width on the mask, i.e. ΔCD=h(W′)*ΔW, where h() denotes the said derivative function and W′ denotes the nominal line width on the mask;
I. selecting various subsets of the data set CD(x,y,cat,i) containing a limited set of categories (cat) and/or a limited number of sites within the optical field and determining the mask correction amounts Z(cat,sample) using this limited data set by either the methods of claims 8, 9, 10, 11, 13, 14, 16, or 17, or any other mask correction method apparent to one of ordinary skill in the art (noting that correction amounts for categories not included are estimated, usually through interpolation);
J. computing the changes in CD, corresponding to each of the mask correction schemes of step I, using the derivative function determined in step H, i.e.
deltaCD(x,y,cat,sample)=h(W′)*Z(x,y,cat,sample);
K. computing each new data set of expected CD values from the original data set, CD′ as
CD″(x,y,cat,i,sample)=CD′(x,y,cat,i,sample)+h(W′)*Z(x,y,cat,sample);
L. selecting a new weighting function for each of the sampling schemes, involving limited numbers of categories, and computing a weighted mean CD″ value for each of the new data sets: mean(CD″,sample);
M. computing the weighted variance for each of the sampling schemes, involving limited numbers of categories, which, for each of the data sets, is the weighted sum of the variances associated with each category in each of the new datasets plus the weighted sum of the squares of the difference between the global mean, mean(CD″,sample), computed in step L, and the category mean for each category in the new data set, to be labeled Var(CD″,sample),
N. computing the standard deviation, σ″(sample), for each of the new data sets, by taking the square root of Var(CD″,sample), where the ratio between σ′ and σ″(sample) provides an indication of improvement from mask correction achieved for each mask correction scheme involving a limited sample of categories and spatial sampling, for a given mask correction resolution.
